(19) United States
(12) Patent Application Publication
(10) Pub. No.: US 2025/0159463 A1
(43) Pub. Date: May 15, 2025

(54) DYNAMICALLY UPDATING SIM CARDS OVER THE AIR

(71) Applicant: DISH Wireless L.L.C, Englewood, CO (US)

(72) Inventors: Prayash Mukherjee, Parker, CO (US); Kevin Karlin, Englewood, CO (US); Robert Urbanek, Englewood, CO (US)

(73) Assignee: DISH Wireless L.L.C., Englewood, CO (US)

(21) Appl. No.: 18/508,931

(22) Filed: Nov. 14, 2023

(51) Int. Cl. H04W 8/18; H04W 8/20

(52) U.S. Cl. CPC H04W 8/183; H04W 8/205

(57) ABSTRACT

An example process of the present disclosure can include the step of generating SIM configurations to dynamically configure a user device in communication with a cellular network. A communication is received from a user equipment (UE) connected to a guest network of the cellular network. The communication can include an identifier associated with the guest network and the UE. A SIM configuration is retrieved from a SIM database using the identifier associated with the guest network and the UE. The example process can update a SIM card of the UE with the SIM configuration from the database. The SIM configuration includes branding for the guest network to display on the UE. The SIM configuration includes network access settings to control communication by the UE with the cellular network.

### TECHNICAL FIELD

The following generally relates to wireless data networks, such as 5G wireless networks. More particularly, the following relates to systems, devices, and automated processes to dynamically configure physical or electronic subscriber identity modules (SIMs) within a 5G or similar wireless network.

### BACKGROUND

Wireless networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers, and other devices. 5G technologies are capable of supplying much greater bandwidths than were previously available, and it is likely that the widespread deployment of 5G networks could radically expand the number of services available to customers.

For example, some attempts have been made to share assigned spectrum between multiple networks. These attempts have faced various challenges. The so-called “neutral host” model, for example, allows one network provider to lease bandwidth on its own network to other parties. The neutral host generally recognizes the lessee's “roaming” traffic on its own network, and then forwards such traffic to the lessee, generally for a fee. In this model, however, the “neutral host” maintains full access and control of its own network, and the other providers that are leasing space on the network must relinquish a substantial amount of flexibility, security, and control over their data traffic. And even to the limited extent that some wireless providers may lease dedicated portions of their spectrum to other providers, this access still lacks the flexibility and independence that are generally desired from operating an independent network to deliver tailored customer experiences.

There is an increased demand for marketing and selling telecommunications services to specific, targeted customer segments. The Mobile Virtual Network Operator (MVNO), for example, has been successful in this approach targeting segments across affordability, geographic, and billing needs. The access has been so notable that some MVNOs have been acquired by Mobile Network Operators (MNOs) such as, for example, the acquisition of TracFone by Verizon®. Some MNOs have begun investing in their own internal brands in an attempt to replicate the marketing successes of MVNOs (e.g., Visible by Verizon®). There is also a desire to prototype new brands that are distinct from the parent company brands or to separate consumers from enterprise brands.

A substantial desire therefore exists to build systems, devices, and automated processes that facilitate convenient customization of a user experience between multiple network operators. In particular, there is a need to dynamically deploy a wide range of network services to customers.

### BRIEF SUMMARY

Various embodiments support dynamic updates to subscriber-identity-module (SIM) cards on a wireless network to control branding and network access. An example of an automated process can include the step of generating SIM configurations to dynamically configure a user device in communication with a cellular network. A communication is received from a user equipment (UE) connected to a guest network of the cellular network. The communication can include an identifier associated with the guest network and the UE. A SIM configuration is retrieved from a SIM database using the identifier associated with the guest network and the UE. The example process can update a SIM card of the UE with the SIM configuration from the database. The SIM configuration includes branding for the guest network to display on the UE. The SIM configuration includes network access settings to control communication by the UE with the cellular network.

In various embodiments, the identifier included in the communication includes a field stored on the SIM card in a previous SIM configuration. The SIM configuration is transmitted to the UE over a cellular connection to the cellular network. A SIM management system can determine the retrieved SIM configuration differs from an old SIM configuration currently installed on the UE, and it can update the SIM card of the UE with the SIM configuration from the database in response to the retrieved SIM configuration differing from the old SIM configuration. The SIM configuration instructs the UE to connect to a cell site of the cellular network using a predetermined interface of the cell site. The SIM configuration instructs the UE to display a brand of the guest network in a status bar. The SIM configuration instructs the UE to use a predetermined roaming priority. A selection of services is received from an operator of the guest network through a SIM management portal. The SIM configurations are generated to implement the selection of services for the user devices in response to the user devices being subscribed to the guest network. The SIM card of the UE can be updated by transmitting the SIM configuration to the UE through a SIM over-the-air (OTA) service.

An example of a SIM management system for a cellular network includes a SIM management portal that receives branding selections and network access selections from a guest network operator on the cellular network. The selections apply to subscribers of the guest network operator. A SIM service is in communication with the SIM management portal and is configured to generate SIM configurations that implement the branding selections and the network access selections on user devices associated with the guest network operator. A SIM OTA service can be in communication with the user devices over the cellular network. The SIM OTA service is configured to update the user devices with SIM configurations selected by the SIM service. The SIM configurations instruct the user devices to display branding set by the branding selections from the guest operator. The SIM configurations instruct the user devices to use a network resource set by the network access selections from the guest operator.

In various embodiments, the SIM service is configured to receive an identifier associated with a device, a subscriber, or the guest network. The SIM service is configured to select a SIM configuration based on the identifier. A database can be configured to store the SIM configurations that are indexed based on identifiers received from the user devices. The database can be a document-based database. The branding can include a brand of the guest operator for display in a status bar. The network resource can include a predetermined roaming priority or a predetermined communication interface of a cell site of the cellular network.

An example process for execution by UE subscribed to a guest network on a cellular network can include transmitting a communication to a cellular network to trigger a dynamic update for a SIM card of the UE. The communication can include an identifier associated with the UE, the guest network, or a subscriber. A SIM configuration is received from a SIM OTA service of the cellular network. The SIM configuration is selected for the UE based on the identifier. The process can include installing the SIM configuration on the SIM card to configure branding and network access of the UE.

In various embodiments, the process includes determining the SIM configuration matches a previously installed SIM configuration of the SIM card, or installing the SIM configuration on the SIM card in response to the SIM configuration not matching the previously installed SIM configuration. The branding can be rendered on a status bar of the UE in response to installing the SIM configuration. The process can include accessing a predetermined interface of a cell site of the cellular network in response to installing the SIM configuration and using a predetermined roaming priority in response to installing the SIM configuration.

Other embodiments may provide other systems, devices, and automated processes relating to dynamic allocation of 5G wireless resources, as described in additional detail below.

### DRAWING FIGURES

The subject matter of the present disclosure is particularly pointed out and distinctly claimed in the concluding portion of the specification. A more complete understanding of the present disclosure, however, may be obtained by referring to the detailed description and claims when considered in connection with the illustrations.

FIG. 1A illustrates an example of a wireless network that supports dynamically updated SIM values, in accordance with various embodiments.

FIG. 1B illustrates an example system for dynamically updating SIM values for a wireless network, in accordance with various embodiments.

FIG. 2 illustrates an example of a user device receiving a SIM update, in accordance with various embodiments.

FIG. 3 illustrates an example process for execution by a SIM management system to dynamically update SIM cards on a cellular network, in accordance with various embodiments.

FIG. 4 illustrates an example process for execution by UE to dynamically update SIM cards on a cellular network, in accordance with various embodiments.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

A mobile network operator (MNO) supports multiple mobile virtual network operators (MNVO) that maintain different user experiences for their clients using the same underlying network. The MNO enables MNVOs on its system by allocating resources on its own radio units for use by one or more MNVOs (also referred to as guest network operators). This allocation can take place using a provisioning plane that allows guest network operators to select desired times of availability, geographic locations, amounts of bandwidth/available spectrum bands, or other parameters as desired. The provisioning plane communicates with the particular radio units within the 5G network system to apportion the available spectrum amongst the various guest operators as desired. Guest operators maintain their own virtualized network functions (e.g., DUs, CUs, 5G Core, IMS, OSS/BSS), thereby maintaining security and control of their own end-to-end network. Furthermore, each MNVO can select services and content available to its users by customizing SIM cards connected to the MNOs network.

In some embodiments, MNVOs may access a network management portal hosted by the MNO to configure a branding service to update SIMs for the MNVOs subscribers. MNVOs can set branding such as splash screens and network names, roaming priority, data polling, tower connections, regional phone numbers, voice networks, data networks, rate plans, customer pricing and billing, distribution channels, or other configurable services. The MNOs platform may also launch applicable sales and customer relationship management (CRM) tools. For the MNVOs, the management of their own guest networks through the MNOs portal can include selecting services and branding components. The branding service can write entries into a SIM database to roll out the selected services and branding of the MNVO to the SIM cards of the MNVOs subscribers. Relatively large changes to the network can thus be implemented with an over-the-air (OTA) update to a SIM card. An OTA SIM update can be pushed without completely reprogramming devices or installing new SIM cards in user equipment.

Various embodiments described herein deliver MNVO-specific experience to user equipment based on data stored on the SIM card (e.g., a digital SIM, an eSIM, or a traditional SIM card) installed on the device. The SIM card can be dynamically updated in response to communications with user equipment. For example, the first time a phone powers up after delivery, the phone may retrieve SIM data corresponding to its MNVO from the SIM OTA service run by the hosting MNO.

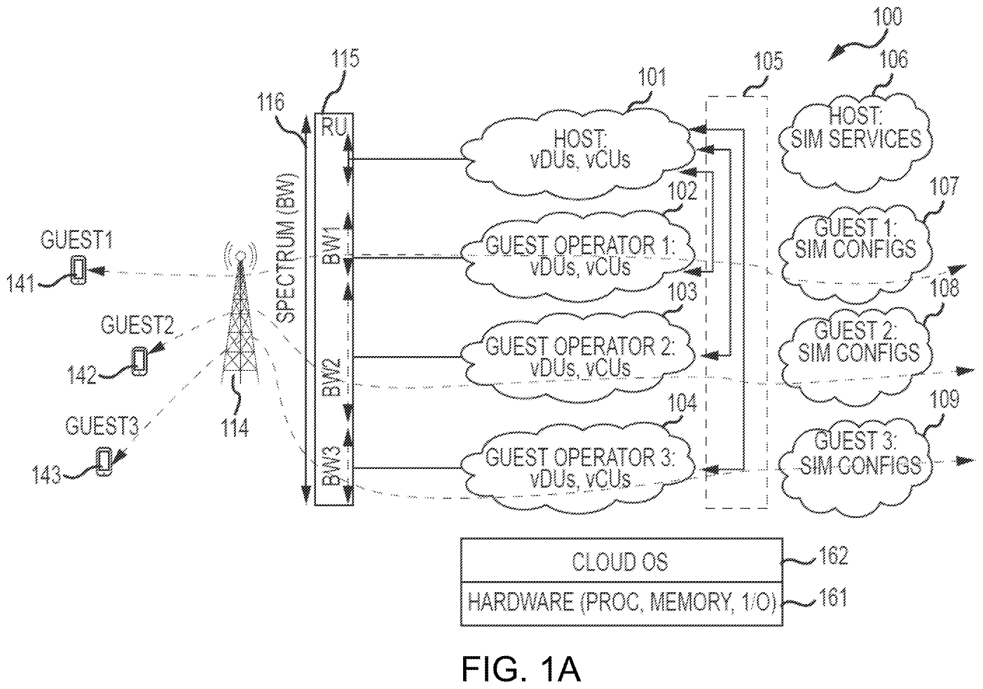

With reference now to FIG. 1A, an example cellular communication system 100 (also referred to herein as a cellular network) is shown, in accordance with various embodiments. Cellular communication system 100 includes a host operator maintaining ownership of one or more radio units (RUs) 115 associated with a wireless network cell. The example of FIG. 1A depicts a host operator operating a “radio/spectrum as a service (R/SaaS)” that allocates bandwidth on its own radio units for use by one or more guest network operators. Examples of guest network operators may include internal brands of the host operator, system integrators, enterprises, external MVNOs, or converged operators. The host and guest network operators may dynamically configure SIM cards on UE 141, 142, 143. Dynamically distributed SIM configurations on UE 141, 142, 143 can configure UE for operation with different network access on guest networks 102, 103, 104.

While FIG. 1A depicts a R/SaaS example, other rudimentary cellular network configurations may be used to dynamically push SIM updates to various UE devices connected to host network 101. R/SaaS systems are described in detail in U.S. patent application Ser. No. 17/566,945, which is incorporated herein by reference for any purpose.

In the example of FIG. 1, each RU 115 communicates with UE 141, 142, 143 operating within a geographic area using one or more antennas/towers 114 capable of transmitting and receiving messages within an assigned spectrum 116 of electromagnetic bandwidth. In various embodiments, guest networks 102, 103, 104 interact with a provisioning plane 105 to obtain the desired spectrum across one or more of the RUs 115 operated by host network 101. Provisioning plane 105 allows guest network operators to obtain or change their assigned bandwidths on different RUs 115 on an on-demand and dynamic basis by dynamically updating a SIM template for the guest network operator.

The Open RAN standard breaks communications into three main domains: the radio unit (RU) that handles radio frequency (RF) and lower physical layer functions of the radio protocol stack, including beamforming; the distributed unit (DU) that handles higher physical access layer, media access (MAC) layer, and radio link control (RLC) functions; and the centralized unit (CU) that performs higher level functions, including quality of service (QOS) routing and the like. The CU also supports packet data convergence protocol (PDCP), service data adaptation protocol (SDAP), and radio resource controller (RRC) functions. The RU, DU, and CU functions are described in more detail in the Open RAN standards, as updated from time to time, and may be modified as desired to implement the various functions and features described herein. In the example of FIG. 1A, host network 101 maintains one or more DUs and CUs as part of its own network. The DU suitably communicates with one or more RUs 115, as specified in the Open RAN standard.

The various network components shown in FIG. 1A are typically implemented using software or firmware instructions that are stored in a non-transitory data storage (e.g., a disk drive or solid-state memory) for execution by one or more processors. The various components shown in FIG. 1A can be implemented using cloud-based hardware 161 and an appropriate operating system 162 such as the Amazon Web Service (AWS) platform provided by Amazon Inc., although other embodiments could use other cloud platforms and/or any type of conventional physical computing hardware 161, as desired.

As illustrated in the example of FIG. 1A, system 100 includes a host network 101 and one or more guest networks 102, 103, 104. The host network 101 is typically operated by an organization that owns radio equipment and sufficient spectrum (potentially on different bands) to offer 5G capacity and coverage. Host network 101 provides 5G service to its own UE, and the host can dynamically manage SIM settings on its own UE or those of its guest operators. Host network 101 includes at least one DU and at least one CU, both of which will typically be implemented virtually using cloud resources.

Guest networks 102, 103, 104 operated by guest operators can manage their own networks using allocated portions of the bandwidth 117, 118, 119 handled by one or more of the RUs 115 associated with the host network 101. The guest networks 102, 103, 104 communicate with one or more UE 141-143 using allocated bandwidth 117, 118, 119 on the host's RU 115. Guest networks 102, 103, 104 may include one or more virtual DUs and CUs, and may communicate with SIM services 106 hosted by the host network. Generally, one or more guest operators will instantiate its own 5G virtualized network functions (e.g., CMS, vCUs, vDUs, etc.) using cloud-based resources, as noted above. However, various embodiments may operate outside of cloud-based environments. Host network 101 may also generate its own SIM configurations to control access available to UE 141-143. Some embodiments may include host network 101 implementing host SIM configurations through wireless communication with UE 141-143, without intervening guest operators hosting guest networks.

Guest operators may lease or otherwise obtain any needed 5G access for its planned services, capacity, and coverage based on an arrangement with the host provider. A guest provider may then operate and manage its own 5G network independently of the host network 101 and the other guests. A network operator can optimize its own network for unique, targeted services by intelligently targeting particular users or subscriber groups with tailored network services.

Each RU 115 is typically associated with a different wireless cell that provides wireless data communications to UE 141-143. RUs 115 may be implemented with radios, filters, amplifiers and other telecommunications hardware to transmit digital data streams via one or more antennas 114. Generally, RU hardware includes one or more processors, non-transitory data storage (e.g., a hard drive or solid-state memory), and appropriate interfaces to perform the various functions described herein. RUs are physically located on-site with the transmitter/antenna/tower 114, as appropriate. Cell sites may comprise access interfaces configurable by SIM settings to manage which interface (e.g., of ten interfaces numbered 0-9) a UE connects to at a cell site. Conventional 5G networks may make use of any number of wireless cells spread across any geographic area, each with its own on-site RU 115. SIM services 106 of host network 101 implementing SIM configurations 107, 108, 109 of guest networks 102, 103, 104 monitor services accessible on each UE communicating with RU 115. Monitoring statistics, data, analytics, and other information may be accessible by guest networks through a portal in communication with SIM services 106, which may include dashboarding and other tools to administer configuration updates to connected UE 141, 142, 143 in accordance with desired guest-network settings.

RUs 115 support wireless communications with any number of UE 141-143. UE 141-143 are often mobile phones or other portable devices that can move between different cells associated with the different RUs 115, although 5G networks are also widely expected to support home and office computing, industrial computing, robotics, Internet-of-Things (IoT), and many other devices. While the example illustrated in FIG. 1A shows one RU 115 for convenience, a practical implementation will typically have any number of RUs 115 that can each be individually configured to provide highly configurable geographic coverage for a guest network, if desired. SIM services 106 may push SIM configurations 107, 108, 109 to UE 141, 142, 143 at regular intervals, on UE provisioning, on UE reboot, in response to UE communicating with a different RU 115 of cellular communication system 100, or on any number of other triggering conditions.

Host network 101 and guest operators 102, 103, 104 can automatically scale and manage UE 141, 142, 143 by dynamically updating SIM configurations 107, 108, 109. In various embodiments, UE 141-143 each include an operating system, which can have different features enabled using different SIM configurations. For example, UE 141-143 in communication with a 5G cellular network can include smart watches, smart phones, laptops, personal computers, servers, internet of things (IoT) devices, connected automobiles, or other computing resources connected to the cellular network and capable of using a SIM.

Referring now to FIG. 1B, system 150 for dynamically updating SIMs is shown, in accordance with various embodiments. The example of FIG. 1B can be used on cellular network 100 of FIG. 1A or with any other cellular network that uses physical or electronic SIM cards that are configurable remotely. Typically, system 150 will configure electronic universal-integrated-circuit cards (e-UICC) that are programmable. Some embodiments may be incompatible with permanently hardcoded SIM configurations.

In various embodiments, MVNOs 102, 103, 104 access a management portal 152. Management portal 152 enables MVNOs to configure their guest networks with various network services and with their own branding. For example, Boost Infinite might configure its guest network to support voice access on the ATT network, data on the DISH network, and roaming priority through T-Mobile on the DISH network. Available network configurations can be selectable through management portal 152.

For example, SIMs can be configured with secret keys. The secret keys can be known by SIM services 106, or can match a public key (e.g., of a private-public-key pair) known by SIM services 106. The secret key can uniquely identify user equipment, can uniquely identify an MNO or MNVO, can uniquely identify a user, or can be configured with other identifying information. The identifying information is used by SIM services 106 to lookup the SIM configuration assigned to a UE 141 in database 154.

SIM services 106 receive configuration requests (e.g., from MNVOs, MNOs, or other cellular brands) submitted through management portal 152. Examples of configuration settings that can be changed directly or indirectly through management portal 152 include branding (e.g., Boost Mobile, Boost Infinite, T-Mobile, ATT, etc.) visible to users interacting with UE. As used herein, branding can thus describe the visual or audible indications on UE 141 of the network to which UE 141 is connected. Other examples of functional configuration settings that can be changed through management portal 152 include PNN (PLMN network name), voice, data, Group Identifier Level (e.g., GID1, GID2), MCC (mobile country code), MNC (mobile network code), roaming priority, data poling, ACC, tower connection interface (e.g., parts 0-9), multi-IMSI (international mobile subscriber identity), or other cellular network configuration settings. The multi-IMSI applet switches the IMSI to the international carrier while roaming globally.

The configuration changes that can be identified in management portal 152 may not translate directly to entries in SIM database 154 in some embodiments. Database 154 will typically store several records for each MNO or MNVO, with different records including different branding or different access to network services for different UE or user subscription levels. SIM services generate and write records in database 154 corresponding to configurations submitted through management portal 152. Database 154 can be a document-based database, a relational database, an unstructured datastore, a structured data store, or any other structure for data storage. Indexing can improve retrieval speeds. In some examples, database 154 can be a document-based database with indexing to improve the speed of record retrieval by SIM services 106 and distribution to UE 141 through SIM OTA 156.

In various embodiments, SIM OTA is a communication service capable of communicating with UE 141 over a cellular network 100 (of FIG. 1). In some examples, SIM OTA 156 can communicate with UE 141 over WiFi or another Internet-based connection for initial SIM configuration or for dynamic SIM configurations when cellular service is unavailable. SIM OTA 156 can run on the same hardware as SIM services 106 in some embodiments (e.g., in a cloud-based 5G network). SIM OTA 156 can run on separate hardware in communication with SIM services 106 over a local area network (LAN) or wide area network (WAN). SIM services 106 instruct SIM OTA which configurations to push to UE 141 based on the identifying information sent from UE 141 to SIM OTA 156.

In various embodiments, SIM services 106 can use identifying information from UE 141 to lookup a SIM configuration in database 154. In some embodiments, UE 141 may send its identifying information to serve as a primary or unique key into database 154. SIM services 106 instruct SIM OTA 156 to send the selected SIM configuration to UE 141 for storage and configuration or reconfiguration.

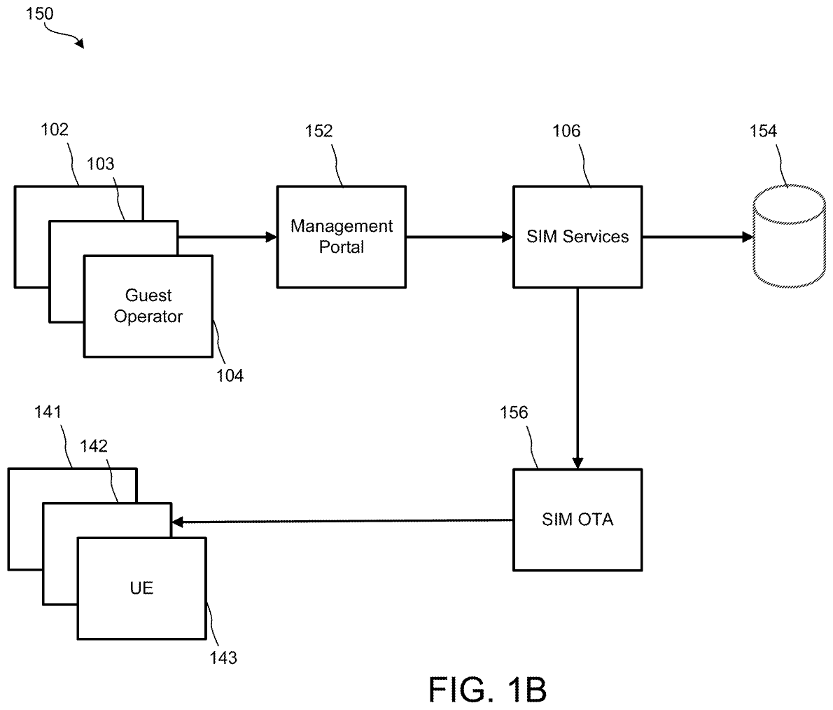

With reference to FIG. 2, UE 141 is shown in communication with SIM management system 220, in accordance with various embodiments. UE 141 includes processor 202, memory 204, and network interface 206. An operating system (OS) 208 may be loaded into memory 204 and executed by processor 202 in response to UE 141 booting. In some examples, the identifier can include an international mobile subscriber identity (IMSI), a token, an integrated circuit card identification (ICCID), an authentication key, or other identifying information storable on SIM card 210. UE 141 may include a device identifier or SIM data readable from SIM card 210 by OS 208 or processor 202. UE 141 communicates the device identifier or SIM data to SIM services 106 of SIM management system 220 to identify itself for SIM configuration. SIM services 106 looks up a SIM configuration for UE 141 using the device identifier or SIM data.

In various embodiments, SIM card 210 may include various permanent and reprogrammable fields. SIM OTA 156 of FIG. 1B sends updates to UE 141 including a directory location on the SIM to be updated. For example, SIM OTA 156 can direct a field update to a first GID parameter and a second GID parameter in the same SIM card to reflect user equipment's association with a network provider (e.g., Boost Mobile, T-Mobile, ATT, Verizon, or other cellular operators). The GID fields may be used to identify the MNVO associated with UE 141 or the service level associated with UE 141. For example, the first GID parameter may identify the MNVO through which UE 141 connects to the cellular network, and the second GID parameter may identify the branding 214 and network access 212 that UE 141 should use. In that regard, a single GID parameter, or both GID parameters in combination, may serve as a key to identify the branding and network access available to UE 141. Although GID fields are used as an example, other fields in the SIM can be used to identify MNVO (or MNO) and branding 214 or network access 121.

The various components of SIM management system 220 shown in FIG. 2 can be implemented using cloud-based hardware and an appropriate operating system, although other embodiments could use other cloud-based platforms and/or any type of conventional physical computing hardware, as desired. Examples of suitable hardware for running SIM management system 220 include processor 222, memory 224, and network interface 226, though SIM management system 220 can be implemented in multiple, separate computing devices or computing environments.

UE 141 communicates through SIM OTA 156 with SIM management system 220. Network interface 206 transmits cellular communications through a cellular communication system (e.g., system 100 of FIG. 1) to SIM management system 220. UE 141 can communicate with and through the cellular network to maintain cellular network connectivity. SIM management system 220 of the cellular network can thus have regular contact with UE 141, in response to which SIM management system 220 verifies that network access 212 and branding 214 are installed, accessible, updated, running, or otherwise representative of the appropriate SIM configuration for UE 141 stored in database 154.

In some embodiments, UE 141 can contact SIM management system 220 to retrieve a SIM configuration for SIM card 210 comprising network access 212 and branding 214 in response to UE 141 rebooting or booting for the first time. UE 141 may also contact SIM management system 220 to validate network access 212 and branding 214 in response to entering a roaming service area, in response to booting, in response to SIM management system 220 pushing an update to UE 141, or in response to any suitable trigger for validation.

Embodiments of SIM management system 220 store SIM configurations supported by host 101 and system 100 of FIG. 1, or configurations set by guest operators for distribution to UE 141 of their subscribers. SIM management system 220 maintains a database 154 of information related to network access 212 and branding 214 installable for UE configured to operate on networks of guest or host operators. Database 154 may include device identifiers, GID parameters, or other identifiers (e.g., stored on SIM cards on UE) associated with predetermined SIM configurations deployable to UE based on the identifiers. Database 154 may also include device configurations, OS versions, compatibility lists, or other criteria to assess network access 212 and branding 214 deployed to UE 141. Database 154 may comprise a relational database, unstructured data store, flat file, structured file, data lake, document-based database, or any other data storage structure or combination thereof.

In various embodiments, guest (and host) operators may access management portal 152 of SIM management system 220 to setup, add, modify, delete, or otherwise manage network access 212 and branding 214 accessible using UE 141 based on the SIM configuration stored on SIM card 210. By writing or overwriting all or part of SIM card 210, SIM management system 220 can open or close access to various network channels, as well as branding, visible on UE 141.

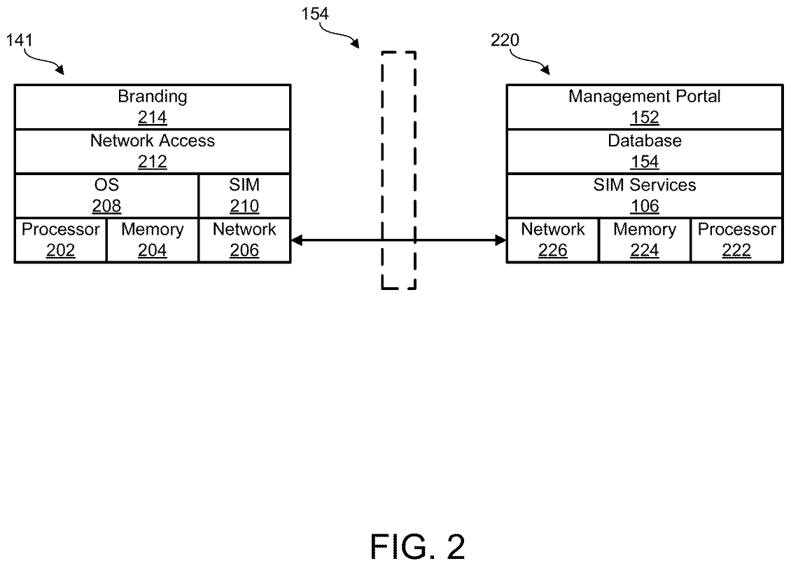

Referring now to FIG. 3 and with continuing reference to FIG. 2, process 300 is shown for dynamically updating SIM cards, in accordance with various embodiments. A MNVO or guest operator (e.g., of guest network 102 in FIG. 1) selects network access 212 and branding 214 for subscriber UE connected to its network. SIM management system 220 may receive the selections through management portal 152. The guest operator can push selected network access 212 and branding 214 to subscriber UE using configuration settings in management portal 152.

In various embodiments, SIM management system 220 receives the selected network access 212 and branding 214 settings for MNVO subscribers (Block 302). The selected settings can be selected in management portal 152 as described above. Selected settings can be received through other communication channels in various embodiments. In response to receiving selected network access 212 and branding 214 settings from an MNVO, SIM management system 220 may generate SIM configurations to implement the selected services on UE subscribed to the MNVO's network (Block 304) (e.g., UE subscribed to guest network 102 of FIG. 1). Once generated, SIM configurations can be stored in database 154. Configurations can be indexed using identifying information stored on UE 141 or SIM card 210. The identifying information can identify a service provider (e.g., MNO or MNVO) to which UE 141 subscribes, the identifying information can identify a service level on the subscribed network, the identifying information can identify the make and model of UE 141, or the identifying information can include any other information suitable for looking up SIM configurations in database 154 for UE 141.

SIM management system 220 can receive a communication including an identifier (Block 306) from UE 141. The identifier typically matches a SIM configuration stored in database 154, though the identifier may not match a SIM configuration if there are no updates to push to the MNVO (or MNO) subscriber UE. SIM management system 220 retrieves the SIM configuration from database 154 based on the received identifier (Block 308). In some embodiments, the identifier or part of the identifier can act as a unique key into database 154 to retrieve a SIM configuration corresponding to the identifier. The identifier can be used to access a lookup table or as a key in conjunction with other information such as, for example, UE make and model, phone number, mac address, UE serial number, or other information retrievable from UE 141.

In various embodiments, the SIM configuration selected or retrieved from database 154 (previously generated in Block 304) can include a location in the file structure of SIM card 210. The location can be in the form of a field or other storage position on SIM card 210. The SIM configuration also includes data to overwrite or write to the identified locations in the SIM file structure. The data dynamically written to SIM card 210 can change branding visible to users of the device (e.g., a logo on a splash screen or an MNVO name in a status bar). The data dynamically written to SIM card 210 can also change network access 212 available to UE 141. For example, the data written to SIM card 210 can change the host network used for roaming service on UE 141 from ATT to T-Mobile. In another example, the data written to SIM card 210 can change the voice telephone number or roaming telephone number of UE 141. In yet another example, the data written to SIM card 210 can change the cellular communication interface (e.g., 0-9) it communicates through on cellular towers. The foregoing examples are not intended to be limiting, and SIM data written to SIM card 210 can reconfigure any suitable type of network access 212 or branding 214.

In various embodiments, SIM management system 220 checks whether SIM card 210 of UE 141 is configured with the retrieved SIM configuration (Block 310). A hash of the SIM configuration installed on UE 141 can be compared to a hash of the retrieved SIM configuration to determine whether the configurations match. An update date of the SIM configuration currently installed on UE 141 can be compared to an update date of the SIM configuration stored in database 154 to determine whether SIM card 210 has been updated since the latest revision of the SIM configuration was added to database 154. If the installed and retrieved SIM configurations are the same, SIM management system 220 may continue listening for incoming communications that trigger SIM management activities. If the installed and retrieved SIM configurations are different, SIM management system 220 may update the SIM configuration of SIM card 210 on UE 141 (Block 312). The SIM configuration of SIM card 210 can be updated by transmitting the SIM configuration to UE 141 for installation on SIM card 210.

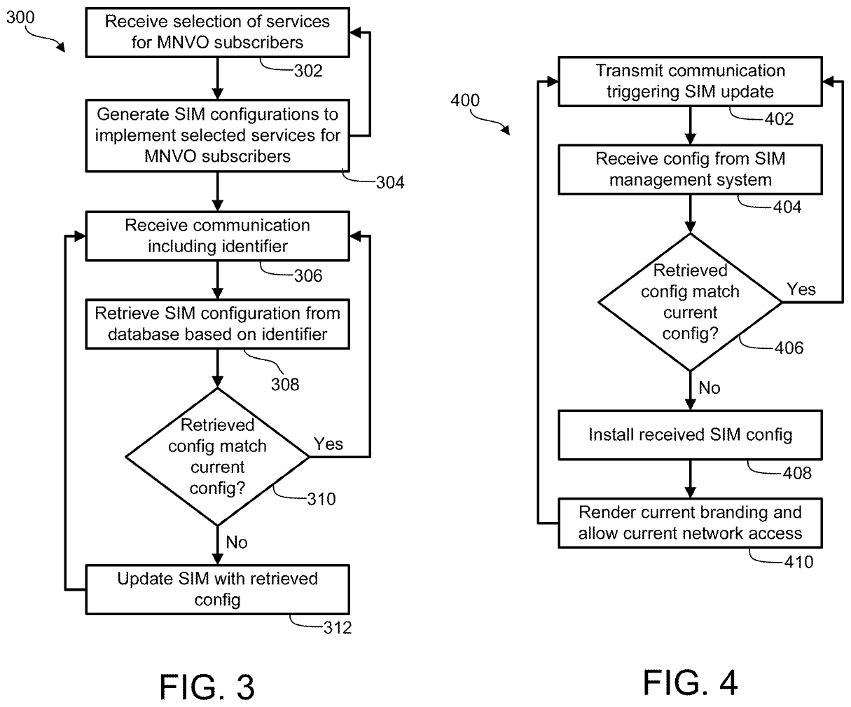

Referring now to FIG. 4, an example process 400 is shown for execution by UE 141 to update SIM card 210. UE 141 can transmit a communication that triggers a SIM update (Block 402). The communication triggering a SIM update can include authentication to cellular network 100, a handshake, initial communication with a cell tower, or other communication on cellular network 100 that triggers an update to SIM card 210 on UE 141. The update can include UE 141 transmitting an identifier stored on UE 141 or on SIM card 210 to SIM management system 220. SIM management system 220 can retrieve the corresponding SIM configuration and transmit the SIM configuration along with any ancillary data to UE 141. UE 141 may receive the SIM configuration from SIM management system 220 (Block 404).

In various embodiments, UE 141 or SIM management system 220 can check whether the SIM configuration currently installed on UE 141 matches the SIM configuration stored in database 154 (Block 406). Techniques described above may be used to determine whether the installed SIM configuration matches database 154, though any other suitable update verification technique can also be used to check whether the SIM configurations match.

UE 141 can write the received SIM configuration to SIM card 210 (Block 408). The received SIM configuration may be installed in response to the SIM configuration retrieved from database 154 differing from the SIM configuration previously installed on UE 141. UE 141 may then access the updated SIM configuration to render current branding 214 and use the currently configured network access 212 provisioned in the updated SIM configuration (Block 410).

Systems, methods, and devices of the present disclosure enable dynamic SIM card updates over a wireless network. The SIM card can control branding displayed on subscriber UE as well as network access used by the subscriber UE. Guest operators can use the dynamic SIM updates to manage subscriber access on their guest networks without pushing comprehensive software updates to UE. Dynamically updated SIM cards enable rapid deployment of network configuration changes in a telephone network that provisions network access through SIM cards, and dynamic SIM updates also enable rapid branding and display changes on subscriber UE. UE can be moved between different guest networks, between different host networks, or between other resources in a manner that tends to appear seamless to the end user. SIM configurations can be dynamically updated in seconds during a load or boot process and before a user can see incorrect branding or can gain access to incorrect network resources.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment (for example, A and B, A and C, B and C, or A and B and C).

References to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device.

What is claimed is:

1. An automated process comprising:
generating a plurality of subscriber-identity-module (SIM) configurations to dynamically configure a plurality of user devices in communication with a cellular network;
receiving a communication from a user equipment (UE) connected to a guest network of the cellular network, wherein the communication comprises an identifier associated with the guest network and the UE;
retrieving a SIM configuration from a SIM database using the identifier associated with the guest network and the UE; and
updating a SIM card of the UE with the SIM configuration from the database, wherein the SIM configuration includes branding for the guest network to display on the UE, wherein the SIM configuration includes network access settings to control communication by the UE with the cellular network.

2. The automated process of claim 1, wherein the identifier included in the communication comprises a field stored on the SIM card in a previous SIM configuration.

3. The automated process of claim 1, wherein the SIM configuration is transmitted to the UE over a cellular connection to the cellular network.

4. The automated process of claim 1, further comprising:
determining the retrieved SIM configuration differs from an old SIM configuration currently installed on the UE; and
updating the SIM card of the UE with the SIM configuration from the database in response to the retrieved SIM configuration differing from the old SIM configuration.

5. The automated process of claim 1, wherein the SIM configuration instructs the UE to connect to a cell site of the cellular network using a predetermined interface of the cell site.

6. The automated process of claim 1, wherein the SIM configuration instructs the UE to display a brand of the guest network in a status bar.

7. The automated process of claim 1, wherein the SIM configuration instructs the UE to use a predetermined roaming priority.

8. The automated process of claim 1, further comprising receiving a selection of services from an operator of the guest network through a SIM management portal, wherein the SIM configurations are generated to implement the selection of services for the user devices in response to the user devices being subscribed to the guest network.

9. The automated process of claim 1, wherein updating the SIM card of the UE further comprises transmitting the SIM configuration to the UE through a SIM over-the-air (OTA) service.

10. A SIM management system for a cellular network, comprising:
a subscriber-identity-module (SIM) management portal that receives branding selections and network access selections from a guest network operator on the cellular network, wherein the selections apply to subscribers of the guest network operator;
a SIM service in communication with the SIM management portal, wherein the SIM service is configured to generate SIM configurations that implement the branding selections and the network access selections on user devices associated with the guest network operator; and
a SIM over-the-air (OTA) service in communication with the user devices over the cellular network, wherein the SIM OTA service is configured to update the user devices with SIM configurations selected by the SIM service,
wherein the SIM configurations instruct the user devices to display branding set by the branding selections from the guest operator,
wherein the SIM configurations instruct the user devices to use a network resource set by the network access selections from the guest operator.

11. The SIM management system of claim 10, wherein the SIM service is configured to receive an identifier associated with a device, a subscriber, or the guest network, wherein the SIM service is configured to select a SIM configuration from the SIM configurations based on the identifier.

12. The SIM management system of claim 10, further comprising a database configured to store the SIM configurations, wherein the SIM configurations are indexed based on identifiers receivable from the user devices.

13. The SIM management system of claim 12, wherein the database comprises a document-based database.

14. The SIM management system of claim 10, wherein the branding comprises a brand of the guest operator for display in a status bar.

15. The SIM management system of claim 10, wherein the network resource comprises a predetermined roaming priority.

16. The SIM management system of claim 10, wherein the network resource comprises a predetermined communication interface of a cell site of the cellular network.

17. A process for execution by user equipment (UE) subscribed to a guest network on a cellular network, the process comprising:
transmitting a communication to a cellular network to trigger a dynamic update for a SIM card of the UE, wherein the communication includes an identifier associated with the UE, the guest network, or a subscriber;
receiving a SIM configuration from a SIM OTA service of the cellular network, wherein the SIM configuration is selected for the UE based on the identifier; and
installing the SIM configuration on the SIM card to configure branding and network access of the UE.

18. The process of claim 17, further comprising:
determining the SIM configuration does not match a previously installed SIM configuration of the SIM card; and
installing the SIM configuration on the SIM card in response to the SIM configuration not matching the previously installed SIM configuration.

19. The process of claim 17, further comprising rendering the branding on a status bar of the UE in response to installing the SIM configuration.

20. The process of claim 17, further comprising:
accessing a predetermined interface of a cell site of the cellular network in response to installing the SIM configuration; and
using a predetermined roaming priority in response to installing the SIM configuration.
